(19) United States
(12) Patent Application Publication
(10) Pub. No.: US 2009/0307529 A1
(43) Pub. Date: Dec. 10, 2009

(54) System for Automatically Attaching RFID Tag Label and Method Thereof

(75) Inventor: Tae Ho Kim, Yongin-Si (KR)

Correspondence Address: THE WEBB LAW FIRM, P.C., 700 KOPPERS BUILDING, 436 SEVENTH AVENUE, PITTSBURGH, PA, 15219, US

(73) Assignee: SAMSUNG SDS CO., LTD., Seoul (KR)

(21) Appl. No.: 12/299,559

(22) PCT Filed: Dec. 8, 2006
(86) PCT No.: PCT/KR2006/005304

§ 371 Date: Jan. 21, 2009

(30) Foreign Application Priority Data
May 10, 2006 (KR) 10-2006-0041946

(51) Int. Cl. G08B 21/00; G06F 11/00

(52) U.S. Cl. 714/37; 340/540; 714/E11.002

(57) ABSTRACT

A system for automatically attaching a radio frequency identification (RFID) tag label and a method thereof are provided. The system includes: an RFID printer for writing original tag information of an object to an RFID tag attached to one surface of the RFID tag label, printing a bar code on the other surface, and outputting the RFID tag label; an applicator for fixing in place the RFID tag label output by the RFID printer and attaching the RFID tag label to the object by applying predetermined pressure; a verification RFID reader including an antenna located near the applicator for reading the written original tag information to verify whether the tag information is correctly recognized from the RFID tag label attached to the object; a warning device for warning a user when the tag information is not correctly recognized from the RFID tag label attached to the object; and a control device for performing control to deliver the original tag information of the object from the exterior to the RFID printer, receiving the read tag information from the verification RFID reader, comparing the read tag information with the original tag information of the object to determine whether the read tag information is consistent with the original tag information, and controlling operation of the warning device based on the determination result, thereby preventing, in advance, errors such as erroneous information for an object distributing process from being generated due to recognition failure, errors and the like.

### TECHNICAL FIELD

The present invention relates to a system for automatically attaching a radio frequency identification (RFID) tag label and a method thereof, and more particularly, to a system for automatically attaching an RFID tag label and a method thereof capable of preventing, in advance, errors such as erroneous information about an object distributing process from being generated due to recognition failure, errors and the like by reading tag information from an RFID tag label automatically attached to an object and verifying whether the tag information is correctly recognized.

### BACKGROUND ART

An applicator comprising a radio frequency identification (RFID) antenna attached on a surface of the applicator's head for reading and writing a tag while attaching a tag label to a box is disclosed in U.S. Patent Laid-open Publication No. 2005/0,194,442 A1 entitled “Label Applicator with RFID Antenna.”

The structure of the conventional applicator having the antenna disposed on its head is simple. However, the applicator is used to repeatedly attach tags to boxes under considerable air pressure and the head has insufficient durability for this task. There also may be difficulty in handling an antenna cable, and forward/backward movement of an arm of the applicator may damage the antenna cable and/or a power cable.

Furthermore, as the antenna is attached on the surface of the head, the tag label needs to be attached on a surface of the antenna other than the head surface. Consequently, it is difficult to mechanically affix the tag label using air pressure.

### DISCLOSURE OF INVENTION

### Technical Problem

It is an object of the present invention to provide a system for automatically attaching an RFID tag label and a method thereof capable of preventing, in advance, errors such as erroneous information for an object distributing process from being generated due to recognition failure, errors and the like by reading tag information, using a separate verification RFID reader or RFID writer/reader, from an RFID tag label automatically attached to an object by an applicator and comparing it with original tag information to verify whether the tag information is correctly recognized.

### Technical Solution

A first aspect of the present invention provides a system for automatically attaching a radio frequency identification (RFID) tag label comprising: an RFID printer for writing original tag information of an object to an RFID tag attached to one surface of the RFID tag label, printing a bar code on the other surface, and outputting the RFID tag label; an applicator for fixing in place the RFID tag label output by the RFID printer and attaching the RFID tag label to the object by applying predetermined pressure; a verification RFID reader including an antenna located near the applicator for reading the written original tag information to verify whether the tag information is correctly recognized from the RFID tag label attached to the object; a warning device for warning a user when the tag information is not correctly recognized from the RFID tag label attached to the object; and a control device for performing control to deliver the original tag information of the object from the exterior to the RFID printer, receiving the read tag information from the verification RFID reader, comparing the read tag information with the original tag information of the object to determine whether the read tag information is consistent with the original tag information, and controlling operation of the warning device based on the determination result.

A second aspect of the present invention provides a system for automatically attaching an RFID tag label comprising: a roll feeding device for feeding the RFID tag label having an RFID tag attached on one surface using a plurality of rollers; a verification RFID writer/reader including an antenna located near the roll feeding device for writing original tag information of an object to the RFID tag of the RFID tag label fed by the roll feeding device, and reading the written original tag information to verify whether the tag information is correctly recognized from the RFID tag label attached to the object; an applicator for fixing in place the RFID tag label fed by the roll feeding device and attaching the RFID tag label to the object by applying predetermined pressure; a warning device for warning a user when the tag information is not correctly recognized from the RFID tag label attached to the object; and a control device for performing control to deliver the original tag information of the object from the exterior to the RFID writer/reader, receiving the read tag information from the verification RFID writer/reader, comparing the read tag information with the original tag information of the object to determine whether the read tag information is consistent with the original tag information, and controlling operation of the warning device based on the determination result.

Here, the system may further comprise a monitoring device for displaying an inconsistency message under control of the control device when the original tag information of the object is inconsistent with the read tag information.

The system may further comprise an antenna subsidiary metal member in the form of a cap disposed around the antenna for preventing a radio signal emitted from the antenna of the verification RFID reader or the verification RFID writer/reader from affecting other RFID tags.

The warning device may comprise a warning lamp or a speaker for notifying the user with light or sound.

A third aspect of the present invention provides a method for attaching an RFID tag label to an object using a system comprising an RFID printer for outputting the RFID tag label including an RFID tag and a bar code, an applicator for attaching the RFID tag label to the object, and a verification RFID reader for reading tag information from the RFID tag label, the method comprising the steps of: (a) writing, by the RFID printer, original tag information of the object to the RFID tag; (b) fixing in place, by the applicator, the RFID tag label output by the RFID printer and attaching the RFID tag label to the object by applying predetermined pressure; (c) reading, by the verification RFID reader, the written original tag information to verify whether the tag information is correctly recognized from the attached RFID tag label; (d) comparing the read tag information with the original tag information of the object to determine whether the read tag information is consistent with the original tag information; and (e) warning a user with light and/or sound when the read tag information is inconsistent with the original tag information of the object in step (d).

A fourth aspect of the present invention provides a method for attaching an RFID tag label to an object using a system comprising a roll feeding device for feeding the RFID tag label including an RFID tag, an applicator for attaching the RFID tag label to the object, and a verification RFID writer/reader for writing and reading tag information to and from the RFID tag label, the method comprising the steps of: (a) writing, by the verification RFID writer/reader, original tag information of the object to the RFID tag of the RFID tag label fed by the roll feeding device; (b) fixing in place, by the applicator, the RFID tag label fed by the roll feeding device and attaching the RFID tag label to the object by applying predetermined pressure; (c) reading, by the verification RFID writer/reader, the written original tag information to verify whether the tag information is correctly recognized from the attached RFID tag label; (d) comparing the read tag information with the original tag information of the object to determine whether the read tag information is consistent with the original tag information; and (e) warning a user with light and/or sound when the read tag information is inconsistent with the original tag information of the object in step (d).

### ADVANTAGEOUS EFFECTS

According to the system for automatically attaching an RFID tag label and the method thereof of the present invention described above, it is possible to prevent, in advance, errors such as erroneous information for an object distributing process from being generated due to recognition failure, errors and the like, by reading tag information, using a separate verification RFID reader or RFID writer/reader, from an RFID tag label automatically attached to an object by an applicator and comparing it with original tag information to verify whether the tag information is correctly recognized.

### BRIEF DESCRIPTION OF THE DRAWINGS

FIG. 1 is a schematic block diagram of a system for automatically attaching a radio frequency identification (RFID) tag label according to a first exemplary embodiment of the present invention;

FIG. 2 is a flowchart illustrating a method for automatically attaching an RFID tag label according to a first exemplary embodiment of the present invention;

FIG. 3 is a schematic block diagram of a system for automatically attaching an RFID tag label according to a second exemplary embodiment of the present invention; and

FIG. 4 is a flowchart illustrating a method for automatically attaching an RFID tag label according to a second exemplary embodiment of the present invention.

### MODE FOR THE INVENTION

Hereinafter, exemplary embodiments of the present invention will be described in detail. However, the present invention is not limited to the exemplary embodiments disclosed below and can be implemented in various forms. Therefore, the present exemplary embodiments are provided for complete disclosure of the present invention and to fully convey the scope of the present invention to those of ordinary skill in the art.

### First Exemplary Embodiment

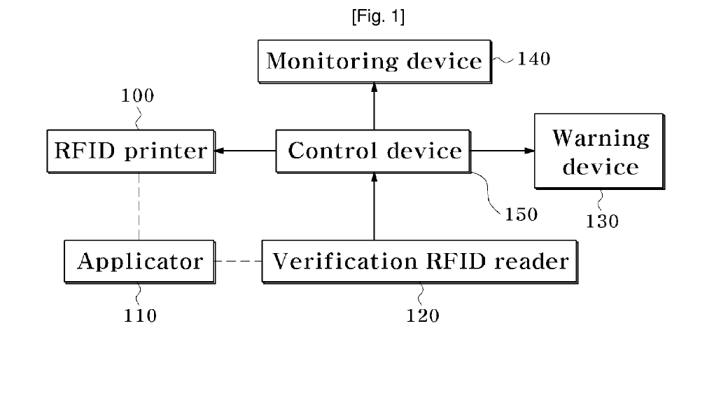

FIG. 1 is a schematic block diagram of a system for automatically attaching a radio frequency identification (RFID) tag label according to a first exemplary embodiment of the present invention.

Referring to FIG. 1, the system for automatically attaching an RFID tag label according to a first exemplary embodiment of the present invention includes an RFID printer 100, an applicator 110, a verification RFID reader 120, a warning device 130, a monitoring device 140, and a control device 150.

In response to a control signal from the control device 150, the RFID printer 100 writes original tag information of a specific object (e.g., information for identifying or discriminating the object, and information about all processes including producing, distributing, storing and selling the object) to an RFID tag attached to one surface of the label, prints a bar code on the other surface, and outputs an RFID tag label.

Such an RFID printer 100 is well known and disclosed, for example, in European Patent No. 0 996 084 A2 entitled “Device for Printing on a Medium” and U.S. Pat. No. 5,229,587 entitled “Bar Code Label Printer and Bar Code Label Issuing Method.”

RFID tags may be generally classified into two types of RFID tags depending on whether they have a battery therein: one being an active tag having a battery therein and the other being a passive tag powered as the tag enters a reader's coverage.

The active tag has a battery therein and carries an RF signal at prescribed time intervals during the duration of the battery. The active tag has remote data transmission and reception capability, but is expensive and has a limited use period dependent on the lifetime of the battery.

The passive tag is composed of an antenna coil and a chip. When a tag enters an electromagnetic field emitted by the reader, an AC voltage is induced in the antenna coil of the tag and rectified into a DC voltage for the chip. When such a voltage is applied to the tag chip, the chip operates to transmit data to the reader. This is often called backscattering.

Most tags have a read range determined by the circuit and size of the antenna, which is generally as short as about 2 to 70 cm. The tags are widely used in the field of distribution, production, traffic and domestic animal management because they are inexpensive.

The applicator 110 fixes the RFID tag label output by the RFID printer 100, for example, to its head as described in connection with the conventional art, and automatically attaches the RFID tag label to an object to be recognized by applying predetermined pressure (e.g., air pressure).

The applicator 110 may include an applicator unit, an arm, and a head as disclosed in U.S. Patent Laid-open Publication No. 2005/0,194,442 A1 entitled “Label Applicator with RFID Antenna.” In this case, the arm automatically operates in synchronization with a time when the RFID printer 100 outputs the RFID tag label, such that the RFID tag label is fixed to a bottom surface of the head of the applicator and exactly attached to the object at its attachment position.

Further, a suitable applicator is disclosed, for example, in U.S. Pat. No. 5,342,461 entitled “High Speed Continuous Conveyor Printer/applicator” and U.S. Pat. No. 5,232,539 entitled “Object Labeling Machine.”

The verification RFID reader 120 is located near the applicator 110 for reading the original tag information written by the RFID printer 100 and transmitting it to the control device 150, which verifies whether the tag information is correctly recognized from the RFID tag label that is attached to the object.

This verification RFID reader 120 may include an antenna for supplying a voltage to the RFID tag, which is attached to the RFID tag label, through a radio frequency and receiving a signal transmitted from the RFID tag, and/or an RFID reader for reading RFID information from the RFID tag.

Preferably, the verification RFID reader 120 further includes, for example, an antenna subsidiary metal member (not shown) in the form of a cap disposed around the antenna for preventing the radio signal emitted from the antenna from affecting other RFID tags.

While the verification RFID reader 120 according to the first exemplary embodiment of the present invention is separate and located near the applicator 110, the present invention is not limited to such an arrangement. Alternatively, the verification RFID reader 120 may be integrated into the applicator 110.

Preferably, in the verification RFID reader 120, the antenna is sized to prevent forward/backward movement of the applicator arm from obstructing attachment of the RFID tag label to the object, or RF transmission output of the verification RFID reader 120 is adjusted not to affect other RFID tag labels.

The warning device 130 warns a user in response to a control signal output from the control device 150 when the tag information is not correctly recognized from the RFID tag label attached to the object.

Such a warning device 130 is preferably implemented by a warning lamp or a speaker for notifying the user with light or sound.

The monitoring device 140 displays an inconsistency message to the user in response to a control signal output from the control device 150 at a time when it is determined that the original tag information of the object is not consistent with the read tag information.

The control device 150 outputs a control signal to receive original tag information to be written to an RFID tag of an RFID tag label attached to a specific object from an external legacy system and deliver it to the RFID printer 100.

The control device 150 receives the read tag information from the verification RFID reader 120 and compares it with original tag information of the object in order to determine whether the read tag information is consistent with the original tag information.

The control device 150 controls operation of the warning device 130 and the monitoring device 140 based on the determination result.

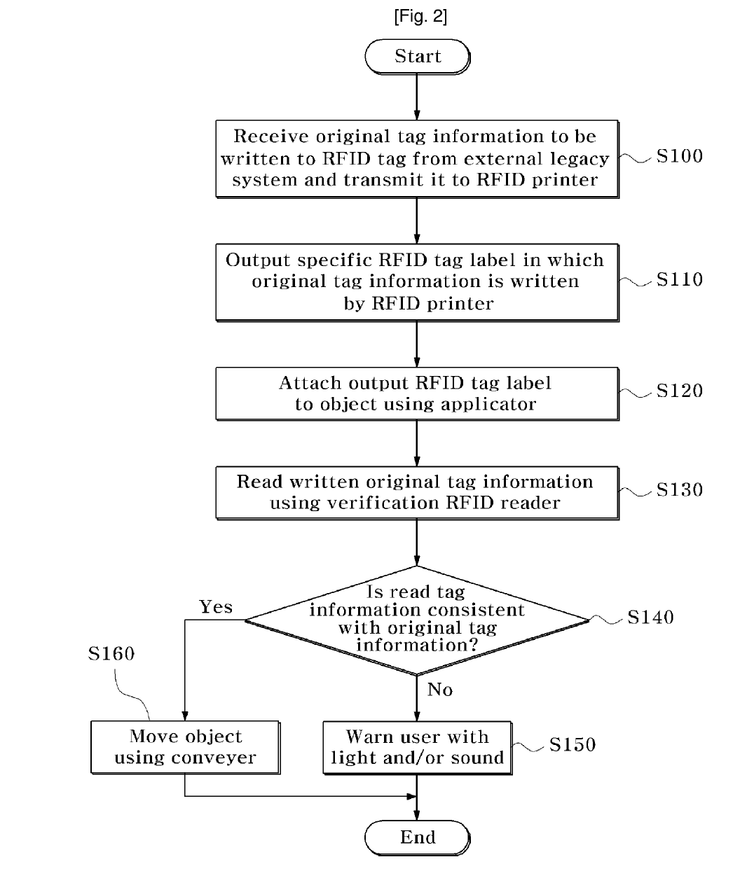

FIG. 2 is a flowchart illustrating a method for automatically attaching an RFID tag label according to a first exemplary embodiment of the present invention, which is performed by the control device 150 (see FIG. 1) unless mentioned otherwise.

Referring to FIG. 2, the control device 150 receives original tag information to be written to the RFID tag from an external legacy system and transmits it to the RFID printer 100 (see FIG. 1) (S100).

Based on the received original tag information, the RFID printer 100 then outputs a specific RFID tag label in which the original tag information of the object is written to an RFID tag attached to one surface and a bar code is printed on the other surface (S110).

The applicator 110 (see FIG. 1) fixes and attaches the RFID tag label output by the RFID printer 100 to the object by applying predetermined pressure (e.g., air pressure) (S120). That is, the arm of the applicator 110 operates in synchronization with issuance of the RFID tag label by the RFID printer 100, such that the RFID tag label is fixed to a bottom surface of a head of the applicator and exactly attached to the object at its attachment position.

In order to verify whether the tag is erroneously recognized due to physical deformation such as a tear in the RFID tag label, i.e., check whether a tag antenna line of the RFID tag label is cut or a chip is broken by external force from air pressure in the tag attaching mechanism, the verification RFID reader 120 reads the written original tag information (S130).

The control device 150 then compares the read tag information with the original tag information of the object to determine whether the read tag information is consistent with the original tag information (S140), and warns the user with light and/or sound when the read tag information is inconsistent with the original tag information (S150).

That is, when it is determined in step S140 that the read tag information is inconsistent with the original tag information, the control device 150 operates the warning lamp, stops the operation of the system, and outputs an inconsistency message to the user on the monitoring device 140 (see FIG. 1).

An operator manually removes the erroneous RFID tag label and resets the system for re-operation. However, when it is determined in step S140 that the read tag information is consistent with the original tag information, the control device operates a conveyer to move the object to a preset location and continues to perform the process (S160).

### Second Exemplary Embodiment

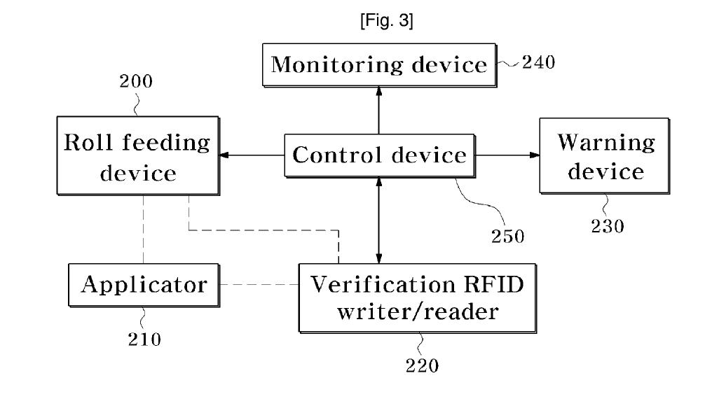

FIG. 3 is a schematic block diagram of a system for automatically attaching an RFID tag label according to a second exemplary embodiment of the present invention.

Referring to FIG. 3, a system for automatically attaching an RFID tag label according to a second exemplary embodiment of the present invention includes a roll feeding device 200, an applicator 210, a verification RFID writer/reader 220, a warning device 230, a monitoring device 240, and a control device 250.

The roll feeding device 200 feeds an RFID tag label having an RFID tag attached on one surface using a plurality of rollers.

The roll feeding device 200 is well known and disclosed, for example, in U.S. Patent Laid-open Publication No. 2003/0,164,974 A1 entitled “Information Conveyance System and Printing Medium Having IC Chips.” In addition, a labeling machine in which pressure sensitive adhesive-backed labels are removably adhered to a backing strip moving along a path from a dispensing roll to a take-up roll is disclosed in U.S. Pat. No. 5,405,482 entitled “Labeling Machine.”

The applicator 210 fixes the RFID tag label fed by the roll feeding device 200, for example, to a head as described in connection with the conventional art, and automatically attaches the RFID tag label to an object to be recognized using predetermined pressure (e.g., air pressure). For further information, reference is made to the first exemplary embodiment of the present invention.

The verification RFID writer/reader 220 is located near the roll feeding device 200 for writing original tag information of a specific object to the RFID tag of the RFID tag label fed by the roll feeding device 200, reading the written original tag information, and transmitting it to the control device 250, which verifies whether the tag information is correctly recognized from the RFID tag label.

This verification RFID writer/reader 220 may include an antenna for supplying a voltage to the RFID tag attached to the RFID tag label, through a radio frequency, receiving a signal transmitted from the RFID tag, and transmitting the tag information to be written to the RFID tag, and/or an RFID reader for reading the RFID information from the RFID tag.

Preferably, the verification RFID writer/reader 220 further includes an antenna subsidiary metal member (not shown) in the form of a cap disposed around the antenna for preventing the radio signal emitted from the antenna from affecting other RFID tags.

While the verification RFID writer/reader 220 according to the second exemplary embodiment of the present invention is separately located near the roll feeding device 200, the present invention is not limited to such arrangement and the verification RFID writer/reader 220 may be integrated with the roll feeding device 200.

Preferably, in the verification RFID writer/reader 220, the antenna is sized to prevent forward/backward movement of the applicator arm from obstructing attachment of the RFID tag label to the object, or RF transmission output of the verification RFID writer/reader 220 is adjusted not to affect other RFID tag labels.

The warning device 230 warns a user in response to a control signal output from the control device 250 at a time when the tag information is not correctly recognized from the RFID tag label attached to the object.

Such a warning device 230 is preferably implemented by a warning lamp or a speaker for notifying the user with light and/or sound.

The monitoring device 240 displays an inconsistency message to the user in response to a control signal output from the control device 250 at a time when it is determined that the original tag information of the object is not consistent with the read tag information.

The control device 250 outputs a control signal to receive original tag information to be written to an RFID tag of an RFID tag label attached to a specific object from an external legacy system and deliver it to the verification RFID writer/reader 220.

The control device 250 receives the read tag information from the verification RFID writer/reader 220 and compares it with the original tag information of the object in order to determine whether the read tag information is consistent with the original tag information. The control device 250 controls operation of the warning device 230 and the monitoring device 240 based on the determination result.

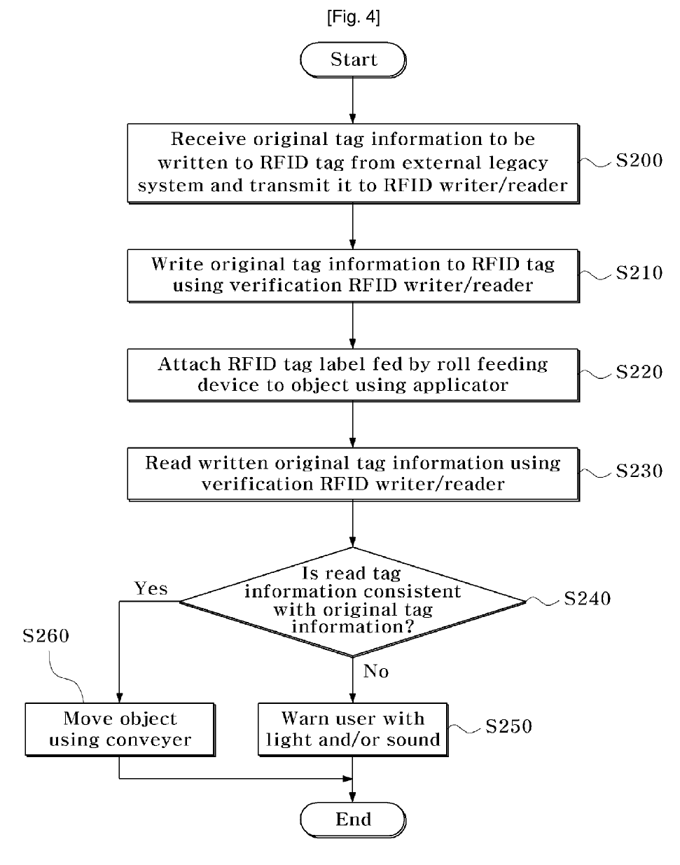

FIG. 4 is a flowchart illustrating a method for automatically attaching an RFID tag label according to a second exemplary embodiment of the present invention, which is performed by the control device 250 (see FIG. 3) unless mentioned otherwise.

Referring to FIG. 4, an RFID tag label having one surface to which only an RFID tag is attached with no printed bar code as in the first exemplary embodiment of the present invention is mechanically fed by a plurality of rollers of the roll feeding device 200 toward the antenna of verification RFID writer/reader 220 with lines of sight (LOS) of the tag label and the antenna matched to each other.

The control device 250 draws out the RFID tag label by a predetermined distance using the roll feeding device 200, receives original tag information to be written to the RFID tag from an external legacy system, and transmits it to the verification RFID writer/reader 220 (S200).

Based on the received original tag information, the verification RFID writer/reader 220 then writes the original tag information to the RFID tag attached to one surface of the RFID tag label (S210).

The applicator 210 (see FIG. 3) fixes and attaches the RFID tag label fed by the roll feeding device 200 to the object using predetermined pressure (e.g., air pressure) (S220). That is, the arm of the applicator 210 operates in synchronization with feeding of the RFID tag label by the roll feeding device 200, such that the RFID tag label is fixed to a bottom surface of a head of the applicator and exactly attached to the object at its attachment position.

In order to verify whether the tag is erroneously recognized due to physical deformation such as a tear in the RFID tag label, i.e., check whether a tag antenna line of the RFID tag label is cut or a chip is broken by external force from air pressure in the tag attaching mechanism, the verification RFID writer/reader 220 reads the written original tag information (S230).

The control device 250 then compares the read tag information with the original tag information of the object to determine whether the read tag information is consistent with the original tag information (S240), and warns the user with light and/or sound when the read tag information is inconsistent with the original tag information (S250).

That is, when it is determined in step S240 that the read tag information is inconsistent with the original tag information, the control device 250 operates the warning lamp, stops the operation of the system, and outputs an inconsistency message to the user on the monitoring device 240 (see FIG. 3).

An operator manually removes the erroneous RFID tag label and resets the system for re-operation. However, when it is determined in step S240 that the read tag information is consistent with the original tag information, the control device operates a conveyer to move the object to a preset location and continues to perform the process (S260).

While the system for automatically attaching an RFID tag label and a method thereof according to the present invention have been described with reference to exemplary embodiments thereof, it will be understood by those skilled in the art that various changes in from and detail may be made therein without departing from the scope of the present invention as defined by the following claims.

1. A system for automatically attaching a radio frequency identification (RFID) tag label, the system comprising:
an RFID printer for writing original tag information of an object to an RFID tag attached to one surface of the RFID tag label, printing a bar code on the other surface, and outputting the RFID tag label;
an applicator for fixing in place the RFID tag label output by the RFID printer and attaching the RFID tag label to the object by applying predetermined pressure;
a verification RFID reader including an antenna located near the applicator for reading the written original tag information to verify whether the tag information is correctly recognized from the RFID tag label attached to the object;
a warning device for warning a user when the tag information is not correctly recognized from the RFID tag label attached to the object; and
a control device for performing control to deliver the original tag information of the object from the exterior to the RFID printer, receiving the read tag information from the verification RFID reader, comparing the read tag information with the original tag information of the object to determine whether the read tag information is consistent with the original tag information, and controlling operation of the warning device based on the determination result.

2. The system of claim 1, further comprising a monitoring device for displaying an inconsistency message under control of the control device when the original tag information of the object is inconsistent with the read tag information.

3. The system of claim 1, further comprising an antenna subsidiary metal member in the form of a cap disposed around the antenna for preventing a radio signal emitted from the antenna of the verification RFID reader from affecting other RFID tags.

4. The system of claim 1, wherein the warning device comprises a warning lamp or a speaker for notifying the user with light or sound.

5. A system for automatically attaching an RFID tag label, the system comprising:
a roll feeding device for feeding the RFID tag label having an RFID tag attached on one surface using a plurality of rollers;
a verification RFID writer/reader including an antenna located near the roll feeding device for writing original tag information of an object to the RFID tag of the RFID tag label fed by the roll feeding device, and reading the written original tag information to verify whether the tag information is correctly recognized from the RFID tag label attached to the object;
an applicator for fixing in place the RFID tag label fed by the roll feeding device and attaching the RFID tag label to the object by applying predetermined pressure;
a warning device for warning a user when the tag information is not correctly recognized from the RFID tag label attached to the object; and
a control device for performing control to deliver the original tag information of the object from the exterior to the RFID writer/reader, receiving the read tag information from the verification RFID writer/reader, comparing the read tag information with the original tag information of the object to determine whether the read tag information is consistent with the original tag information, and controlling operation of the warning device based on the determination result.

6. The system of claim 5, further comprising a monitoring device for displaying an inconsistency message under control of the control device when the original tag information of the object is inconsistent with the read tag information.

7. The system of claim 5, further comprising an antenna subsidiary metal member in the form of a cap disposed around the antenna for preventing a radio signal emitted from the antenna of the verification RFID writer/reader from affecting other RFID tags.

8. The system of claim 5, wherein the warning device comprises a warning lamp or a speaker for notifying the user with light or sound.

9. A method for attaching an RFID tag label to an object using a system comprising an RFID printer for outputting the RFID tag label including an RFID tag and a bar code, an applicator for attaching the RFID tag label to the object, and a verification RFID reader for reading tag information from the RFID tag label, the method comprising the steps of:
(a) writing, by the RFID printer, original tag information of the object to the RFID tag;
(b) fixing in place, by the applicator, the RFID tag label output by the RFID printer and attaching the RFID tag label to the object by applying predetermined pressure;
(c) reading, by the verification RFID reader, the written original tag information to verify whether the tag information is correctly recognized from the attached RFID tag label;
(d) comparing the read tag information with the original tag information of the object to determine whether the read tag information is consistent with the original tag information; and
(e) warning a user with light and/or sound when the read tag information is inconsistent with the original tag information of the object in step (d).

10. A method for attaching an RFID tag label to an object using a system comprising a roll feeding device for feeding the RFID tag label including an RFID tag, an applicator for attaching the RFID tag label to the object, and a verification RFID writer/reader for writing and reading tag information to and from the RFID tag label, the method comprising the steps of:
(a) writing, by the verification RFID writer/reader, original tag information of the object to the RFID tag of the RFID tag label fed by the roll feeding device;
(b) fixing in place, by the applicator, the RFID tag label fed by the roll feeding device and attaching the RFID tag label to the object by applying predetermined pressure;
(c) reading, by the verification RFID writer/reader, the written original tag information to verify whether the tag information is correctly recognized from the attached RFID tag label;
(d) comparing the read tag information with the original tag information of the object to determine whether the read tag information is consistent with the original tag information; and
(e) warning a user with light and/or sound when the read tag information is inconsistent with the original tag information of the object in step (d).
